(19) United States
(12) Patent Application Publication
(10) Pub. No.: US 2024/0143757 A1
(43) Pub. Date: May 2, 2024

(54) INFORMATION PROCESSING APPARATUS AND VIRUS DETECTION DISPLAY METHOD

(71) Applicant: SHARP KABUSHIKI KAISHA, Sakai City (JP)

(72) Inventor: TSUTOMU ITAI, Sakai City (JP)

(21) Appl. No.: 18/384,019

(22) Filed: Oct. 26, 2023

(30) Foreign Application Priority Data
Nov. 2, 2022 (JP) 2022-176633

(51) Int. Cl. G06F 21/56

(52) U.S. Cl. CPC G06F 21/561; G06F 2221/034

(57) ABSTRACT

An information processing apparatus including: one or more controllers that detect a virus and perform a specific measure on a file infected with the virus; and a display that displays that the virus has been detected as display content based on control performed by the one or more controllers, in which the one or more controllers continue to display that the virus has been detected even in a case where the file becomes inaccessible as a result of the specific measure performed on the file.

### TECHNICAL FIELD

The present disclosure relates to an information processing apparatus and the like.

### BACKGROUND ART

Some information processing apparatuses are adapted to notify users of a fact that a virus has been detected when a virus is detected in an input job or data.

For example, a technology of deleting received data received via a network and notifying an apparatus administrator of the fact that a virus has been detected to encourage the apparatus administrator to handle the virus thereafter in a case where a virus is detected in the received data is known.

### SUMMARY

### Technical Problem

An object of the present disclosure is to provide an information processing apparatus and the like capable of accurately providing, to a user, a notification regarding virus detection.

### Solution to Problem

In order to solve the above problem, an information processing apparatus according to the present disclosure includes: one or more controllers that detect a virus and performs a specific measure on a file infected with the virus; and a display that displays that the virus has been detected as display content based on control performed by the one or more controllers, in which the one or more controllers continue to display that the virus has been detected even in a case where the file becomes inaccessible as a result of the specific measure performed on the file.

A virus detection display method according to the present disclosure includes: detecting a virus and performing a specific measure on a file infected with the virus; displaying that the virus has been detected as display content; and continuing to display that the virus has been detected even in a case where the file becomes inaccessible as a result of the specific measure performed on the file.

Advantage Effects of Invention According to the present disclosure, it is possible to provide an information processing apparatus and the like capable of accurately providing, to a user, a notification regarding virus detection.

### BRIEF DESCRIPTION OF DRAWINGS

FIG. 1 is a diagram for explaining an overall configuration of a multifunction peripheral according to a first embodiment.

FIG. 2 is a diagram for explaining a functional configuration of the multifunction peripheral according to the first embodiment.

FIG. 3 is a diagram for explaining a mode of a data structure of a file information table.

FIG. 4 is a diagram for explaining a mode of a data structure of an update information table.

FIG. 5 is a flowchart for explaining a processing flow according to the first embodiment.

FIG. 6 is a flowchart for explaining a processing flow according to the first embodiment.

FIG. 7 is a diagram for explaining an operation example according to the first embodiment.

FIG. 8 is a diagram for explaining an operation example according to the first embodiment.

FIG. 9 is a diagram for explaining an operation example according to the first embodiment.

FIG. 10 is a diagram for explaining an operation example according to the first embodiment.

FIG. 11 is a diagram for explaining an operation example according to the first embodiment.

FIG. 12 is a diagram for explaining an operation example according to the first embodiment.

FIG. 13 is a diagram for explaining an operation example according to the first embodiment.

FIG. 14 is a diagram for explaining an operation example according to the first embodiment.

FIG. 15 is a flowchart for explaining a processing flow according to a second embodiment.

FIG. 16 is a diagram for explaining an operation example according to the second embodiment.

FIG. 17 is a diagram for explaining a functional configuration of a multifunction peripheral according to a third embodiment.

FIG. 18 is a flowchart for explaining a processing flow according to the third embodiment.

FIG. 19 is a diagram for explaining an operation example according to the third embodiment.

### DESCRIPTION OF EMBODIMENTS

Embodiments according to the present disclosure will be described below with reference to the drawings. Note that the following embodiments are examples for describing the present disclosure, and the technical scope of the explanation described in the claims is not limited to the following description.

Some information processing apparatuses capable of reducing a risk of virus infection by cleaning, deleting, or isolating viruses have a function of notifying a user of the fact that a virus has been detected. Since notification content regarding virus detection does not match an actual state of an infected file in a case where the file infected with a virus (hereinafter, may be referred to as infected file) has been cleaned, deleted, or isolated, and the infected file cannot be accessed, or in a case where detection of the infected file itself becomes impossible, the notification regarding virus detection is erased according to a typical operation.

However, if the notification regarding virus detection is erased before the user checks the notification, it is not possible to accurately provide, to the user, a notification that a virus has been detected.

Control for continuing display indicating that a virus has been detected even in a case where an infected file becomes inaccessible as a result of taking a specific measure for realizing cleaning, deletion, or isolation for the file is realized in the following embodiments. The specific measure according to the present disclosure includes an operation/action (regardless of whether the specific measure is an operation performed by a user or an action performed by a specific functional section such as one or more controllers), processing, command reception and the like for realizing cleaning, deletion, and isolation of a virus, such as a change in file name of the infected file, a change in file path indicating a storage location of the infected file, release of mounting of a device storing the infected file, deletion of the infected file, or overwriting and saving of the infected file.

### 1. First Embodiment

In a first embodiment, a multifunction peripheral (image formation apparatus) capable of carrying out jobs in various modes such as printing, copying, scanning, faxing, and Internet faxing in one casing will be described as a mode of the information processing apparatus. The multifunction peripheral according to the first embodiment is a multifunction peripheral including: one or more controllers that detect a virus and performs a specific measure on a file infected with the virus; and a display that displays that the virus has been detected as display content based on control performed by the one or more controllers, in which the one or more controllers continue to display that the virus has been detected even in a case where the file becomes inaccessible as a result of the specific measure performed on the file.

### 1.1 Functional Configuration

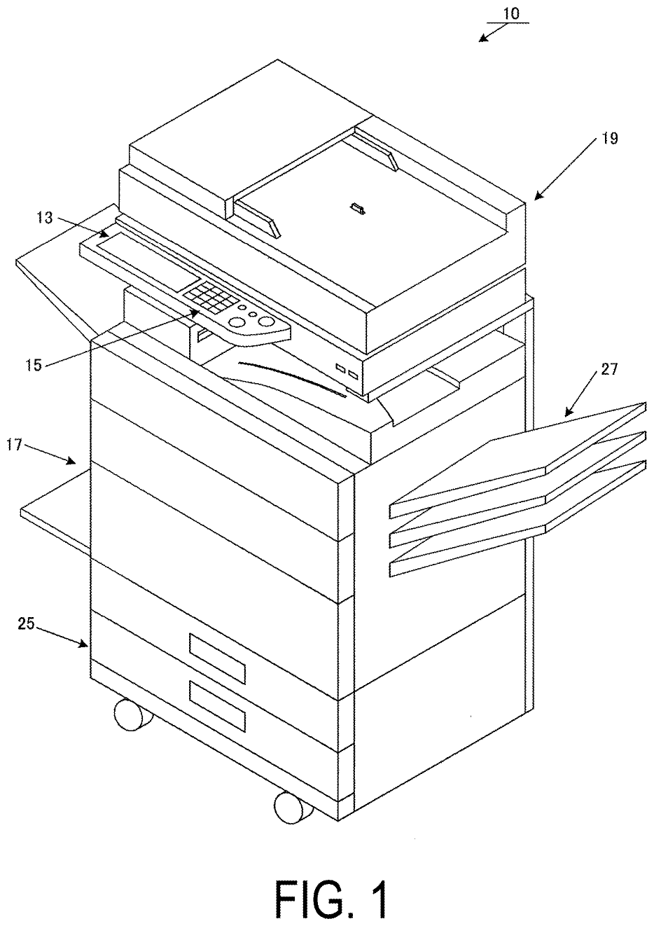

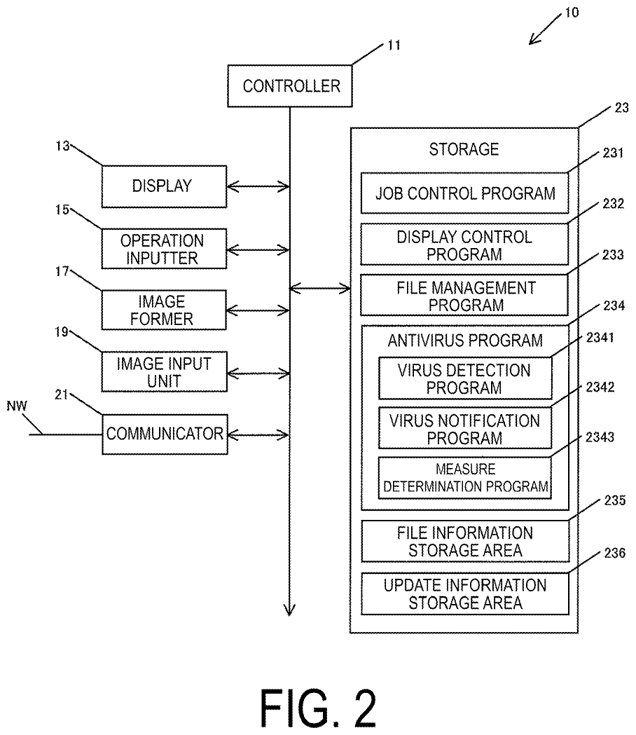

A functional configuration of a multifunction peripheral 10 according to the first embodiment will be described with reference to FIG. 1 and FIG. 2. FIG. 1 is an external perspective view for schematically explaining an overall configuration of the multifunction peripheral 10. FIG. 2 is a functional configuration diagram of the multifunction peripheral 10. The multifunction peripheral 10 includes a controller 11, a display 13, an operation inputter 15, an image former 17, an image inputter 19, a communicator 21, and a storage 23.

The controller 11 controls the entire multifunction peripheral 10. The controller 11 is configured of, for example, one or more arithmetic devices (central processing units (CPUs) or the like). The controller 11 realizes the function thereof by reading and executing various programs stored in the storage 23.

The display 13 displays various types of information for a user or the like. The display 13 can be configured of, for example, a liquid crystal display (LCD), an organic electro-luminescence (EL) display, or the like. The display 13 can display that a virus has been detected as display content based on control performed by the controller 11 reading a display control program 232, which will be described later.

The operation inputter 15 receives an input of information by a user or the like. The operation inputter 15 can be configured of hard keys (for example, a numeric keypad), buttons, and the like. The operation inputter 15 can be configured as a touch panel that allows inputs via the display 13. In this case, a general system such as a resistance film system, an infrared system, an electromagnetic induction system, or a capacitance system, for example, can be used as an input system of the touch panel.

The image former 17 forms an image based on image data input from the image inputter 19 on a sheet as a recording medium. The image former 17 feeds a sheet from a sheet feeder 25, forms an image based on image data on the sheet, and then discharges the sheet to a sheet discharger 27. The image former 17 can be configured of, for example, a laser printer using an electrophotographic system. In this case, the image former 17 performs image formation using a toner supplied from a toner cartridge, which is not illustrated, corresponding to toner colors (for example, cyan, magenta, yellow, and black).

The image inputter 19 can be configured as a scanner device including, for example, an image sensor such as a charge coupled device (CCD) or a charge image sensor (CIS), an automatic document feeder (ADF), a flatbed on which a document is placed to read the document, and the like. In this case, the configuration of the scanner device is not particularly limited as long as the scanner device can generate image data by reading a reflected light image from a document image with an image sensor with the configuration. Note that the image inputter 19 may be configured as an interface capable of acquiring, for example, an image data file stored in a portable storage medium (device) such as a universal serial bus (USB) memory, image data transmitted from an external device, which is not illustrated, via the communicator 21, and the like.

The communicator 21 includes, for example, one or both of wired and wireless interfaces for performing communication with other devices via a network NW such as a local area network (LAN), a wide area network (WAN), the Internet, a telephone line, or a fax line.

The storage 23 stores various programs and various types of data necessary for the operation of the multifunction peripheral 10. The storage 23 may, for example, be configured of a storage device such as a random access memory (RAM), a hard disk drive (HDD), a solid state drive (SSD), or a read only memory (ROM).

In the first embodiment, the storage 23 stores a job control program 231, a display control program 232, a file management program 233, and an antivirus program 234, and secures a file information storage area 235 and an update information storage area 236.

The job control program 231 is a program read by the controller 11 in order to perform processing related to the various modes such as printing, copying, scanning, faxing, and Internet faxing in units of jobs. The controller 11 that has read the job control program 231 executes jobs by controlling the display 13, the operation inputter 15, the image former 17, the image inputter 19, the communicator 21, and the like.

The display control program 232 is a program read by the controller 11 when display control of a display screen via the display 13 is performed. The controller 11 that has read the display control program 232 displays a home screen for receiving switching of a job mode or the like, a setting screen for receiving inputs of various setting values related to execution of a job according to a mode, and the like. The controller 11 performs display control for a notification (message) or the like indicating that a virus has been detected as display content.

The file management program 233 is a program that is read by the controller 11 when each data file to be managed by the multifunction peripheral 10 (simply referred to as a file), such as firmware update data, application data, apparatus setting data, and input/output data regarding execution of jobs, for example, is managed. The controller 11 that has read the file management program 233 manages files to be handled by the multifunction peripheral 10 by accessing each file to be managed, and changing a file name or a file path, deleting the file, overwriting and saving the file, or monitoring a mounting condition of a device storing the file, for example.

The antivirus program 234 is a program that is read by the controller 11 in order to prevent virus infection of files as targets of management of the multifunction peripheral 10, prevent expansion of the virus infection, and the like. The antivirus program 234 includes a virus detection program 2341, a virus notification program 2342, and a measure determination program 2343.

The controller 11 that has read the virus detection program 2341 executes virus scanning for detecting a virus. In this case, the controller 11 can detect a virus by, for example, pattern matching with a virus definition file, which is not illustrated. In a case where a virus is detected, the controller 11 that has read the virus detection program 2341 associates information regarding the infected file with a file ID and stores the information as a file information table in the file information storage area 235. The controller 11 that has read the virus detection program 2341 can receive settings such as a setting of a data (file) type to be subjected to virus scanning, a setting of an execution schedule of virus scanning, and an execution schedule of pattern update of a virus definition file via a setting screen, which will be described later, and register the contents of the settings.

The controller 11 that has read the virus notification program 2342 creates a virus detection message indicating that a virus has been detected as display content based on the file information table stored in the file information storage area 235. In a case where the infected file becomes inaccessible as a result of a specific measure performed on the infected file, the controller 11 can update the virus detection message by changing the notification content regarding the virus detection. In this case, the controller 11 updates the previous (before the specific measures) virus detection message based on an update information table, which will be described later.

The controller 11 that has read the measure determination program 2343 determines the specific measure that has been performed on the infected file and specifies a changed part of the information regarding the infected file resulted from the specific measure. The specified changed part corresponds to the updated part from the previous virus detection message. The controller 11 associates the specific measure with the changed part of the information regarding the infected file resulted from the specific measure and stores it as an update information table in the update information storage area 236.

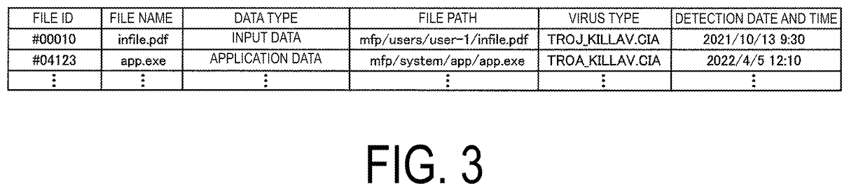

The file information storage area 235 is a storage area for storing information regarding the infected file as a file information table. The file information table will now be described using FIG. 3.

FIG. 3 is a diagram for explaining a mode of a data structure of the file information table. The file information table includes a file ID, a file name, a data type, a file path, a virus type, and a detection date and time as storage items. The file ID is an identifier for uniquely identifying a file to be managed by the multifunction peripheral 10. The file name represents a file name of the infected file. The data type represents a data (file) type of the infected file. The file path indicates a storage destination of the infected file. The virus type indicates the type of the detected virus. The detection date and time indicates the date and time when the virus has been detected.

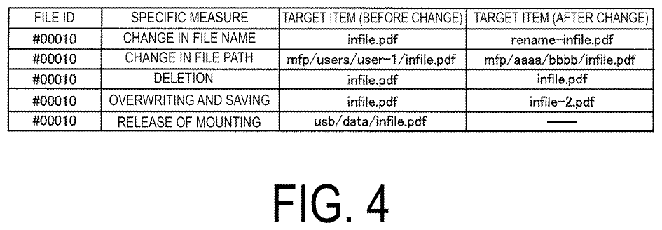

For example, this represents that the infected file identified by the file ID “#00010” has the file name “infile.pdf” and is data input to the multifunction peripheral 10 (data type: “input data”). This represents that the infected file is stored in “mfp/users/user-1”, has been infected by a virus of a type “TROJ_KILLAV.CIA”, and has been detected at “2021/10/13 9:30”. The update information storage area 236 is a storage area that stores an update information table in which a specific measure performed on an infected file is associated with a changed part of information related to the infected file resulted from the specific measure. Note that the controller 11 that has read the virus notification program 2342 can update the previous virus detection message by referring to the update information table in a case where a specific measure is performed on the infected file. The update information table will be described using FIG. 4.

FIG. 4 is a diagram for explaining a mode of a data structure of an update information table. Note that in FIG. 4, a specific measure performed on the infected file identified by the file ID “#00010” illustrated as an example in FIG. 3 will be described as an example. The update information table includes a file ID, a specific measure, a target item (before change), and a target item (after change) as storage items. The file ID is the same as the file ID described in FIG. 3. The specific measure indicates the specific measure performed on the infected file determined by the controller 11 that has read the measure determination program 2343. The target item (before change) is a value of the storage item before the specific measure, and the target item (after change) is a value of the storage item after the specific measure.

For example, a “change in file name” which is a specific measure is an example case where the file name of the infected file identified by the file ID “#00010” has been changed from “infile.pdf” (target item (before change)) to “rename-infile.pdf” (target item (after change)). In a case where the specific measure has been performed on the infected file, the controller 11 that has read the virus notification program 2342 can update the previous virus detection message by changing the value of the target item (before change) associated with the file ID to the value of the target item (after change).

### 1.2 Processing Flow

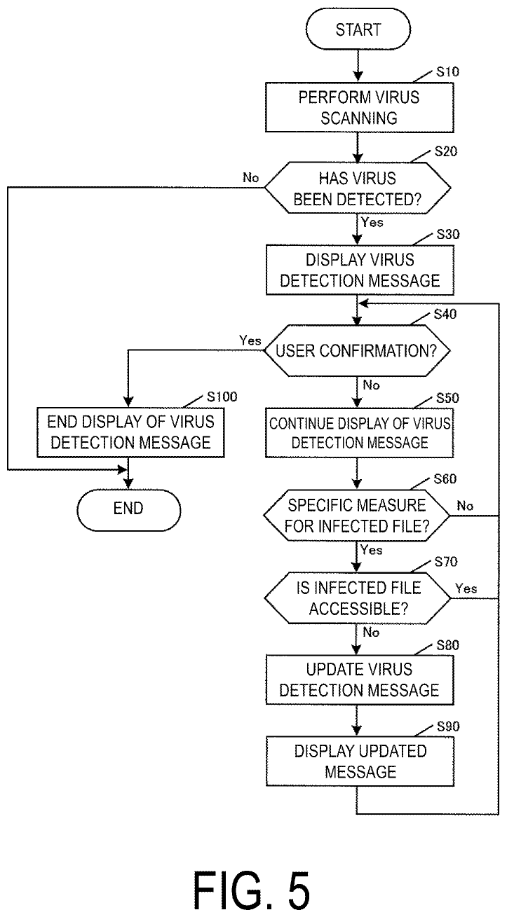

Next, a processing flow according to the first embodiment will be described. FIG. 5 is a flowchart for explaining overall processing according to the first embodiment. Note that the processing described with reference to FIG. 5 is executed by the controller 11 mainly reading the display control program 232, the file management program 233, the antivirus program 234, and the like.

First, the controller 11 reads the virus detection program 2341 on a preset schedule or at a timing of choice at which an execution instruction is input by the user, and thereby executes virus scanning (Step S10).

The controller 11 determines whether a virus has been detected from the file to be subjected to the virus scanning (Step S20). When it is determined that no virus has been detected, the controller 11 ends the processing (Step S20; No→“end”).

On the other hand, in a case where it is determined that a virus has been detected, the controller 11 associates information regarding the infected file infected with the virus with the file ID and stores the information in the file information storage area 235 as the file information table. The controller 11 reads the virus notification program 2342 and creates the virus detection message indicating that a virus has been detected as notification content based on the file information table. The controller 11 displays the created virus detection message on the display 13 (Step S20; Yes→Step S30).

The controller 11 determines whether the virus detection message displayed on the display 13 has been checked by the user (Step S40). In this case, the controller 11 can determine that the virus detection message has been checked by the user by receiving selection of a confirmation button provided on a display screen of the virus detection message, which will be described later, a delete instruction button of the message, or the like.

In a case where it is determined that the virus detection message displayed on the display 13 has been checked by the user, the controller 11 ends the display of the virus detection message and ends the processing (Step S40; Yes→Step S100).

On the other hand, in a case where it is determined that the virus detection message displayed on the display 13 has not been checked by the user, the controller 11 continues the display of the virus detection message (Step S40; No→Step S50).

The controller 11 determines whether the specific measure has been performed on the file related to the virus detection (infected file) by reading the measure determination program 2343 (Step S60). Note that the specific processing performed on the infected file is an operation/action, processing, command reception, or the like for realizing cleaning, deletion, or isolation of a virus, such as a change in file name of the infected file, a change in file path indicating a storage location of the infected file, release of mounting of a device storing the infected file, deletion of the infected file, and overwriting and saving of the infected file. In a case where it is determined that the specific measure has not been performed on the infected file, the controller 11 repeats the processing from Step S40 (Step S60; No→Step S40).

On the other hand, in a case where it is determined that the specific measure has been performed on the infected file, the controller 11 associates the specific measure with the changed part of the information regarding the infected file resulted from the specific measure and stores them as an update information table in the update information storage area 236. The controller 11 determines whether the infected file can be accessed (Step S60; Yes→Step S70). In a case where it is determined that the infected file can be accessed, the controller 11 repeats the processing from Step S40 (Step S70; Yes→Step S40).

When it is determined that access to the infected file is impossible, the controller 11 updates the virus detection message based on the update information table (Step S70; No→Step S80). Next, the controller 11 displays the updated virus detection message and repeats the processing from Step S40 (Step S90→Step S40).

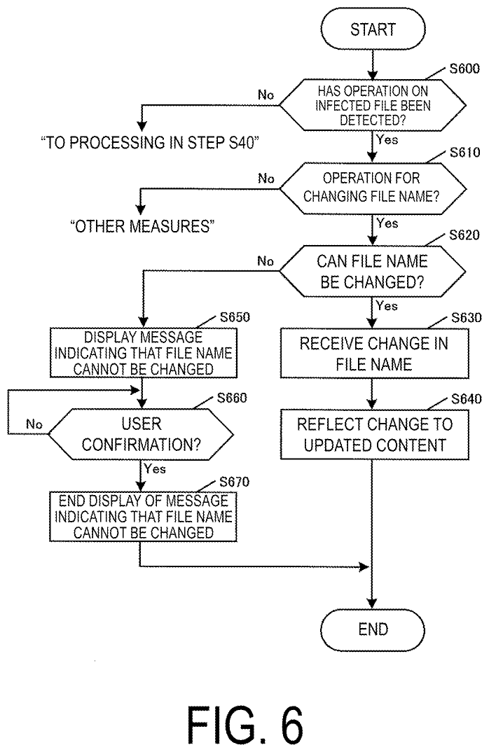

Next, processing in a case where the file name of the infected file has been changed as a mode of a specific measure will be described using the flowchart in FIG. 6. Note that the processing which will be described in the flowchart in FIG. 6 is processing corresponding to the processing in Step S60 in FIG. 5.

First, the controller 11 reads the measure determination program 2343 and detects an operation performed on the infected file (Step S600). In a case where the operation on the infected file is not detected, the controller 11 moves on to the processing in Step S40 in FIG. 5 (Step S600; No→“to the processing in Step S40”).

In a case where the operation on the infected file is detected, the controller 11 determines whether the operation is an operation for changing the file name (Step S600; Yes→Step S610). In a case where it is determined that the operation performed on the infected file is not an operation for changing the file name, the controller 11 determines that the operation is another measure” such as a change in file path, for example (Step S610; No→“another operation”).

In a case where it is determined that the operation performed on the infected file is an operation for changing the file name, the controller 11 determines whether the file name of the infected file can be changed (Step S610; Yes→Step S620). In a case where it is determined that the file name can be changed, the controller 11 receives the change in file name (Step S620; Yes→Step S630). The controller 11 reflects the changed file name to the update information table and ends the processing (Step S640).

On the other hand, in a case where it is determined that the file name cannot be changed, the controller 11 displays, on the display 13, a change unavailability message indicating that the file name cannot be changed (Step S620; No→Step S650).

The controller 11 determines whether the change unavailability message displayed on the display 13 has been checked by the user (Step S660). In this case, the controller 11 can determine that the change unavailability message has been checked by the user by receiving selection of a confirmation button provided on a display screen of the change unavailability message, a delete instruction button of the message, or the like.

In a case where it is determined that the change unavailability message displayed on the display 13 has been checked by the user, the controller 11 ends the display of the change unavailability message and ends the processing (Step S660; Yes→Step S670).

On the other hand, in a case where it is determined that the change unavailability message displayed on the display 13 has not been checked by the user, the controller 11 continues the display of the change unavailability message (Step S660; No).

Incidentally, the processing described in FIG. 6 can be applied not only a measure related to a change in file name of the infected file but also specific measures such as a change in file path of the infected file, deletion of the infected file, overwriting and saving of the infected file, release of mounting of a device storing the infected file, or the like. In this case, the “change in file name” related to Step S610 to Step S630, Step S650, and Step S670 in FIG. 6 may be replaced with a “change in file path”, for example.

### 1.3 Operation Example

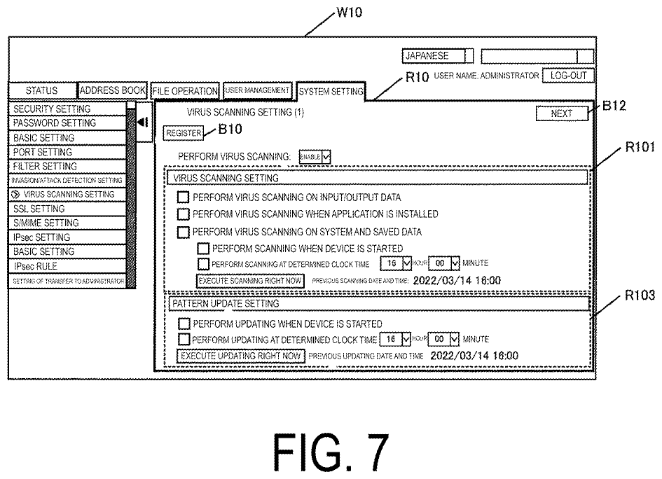

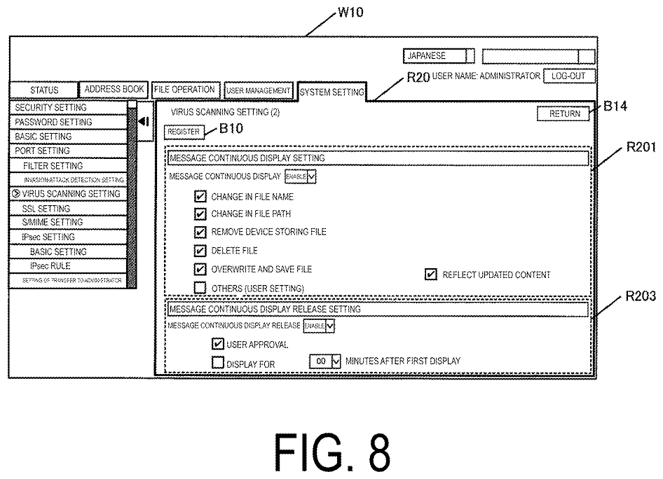

Next, an operation example according to the first embodiment will be described. FIG. 7 and FIG. 8 are diagrams for explaining a configuration example of a display screen W10 that can be displayed on the display 13 by the multifunction peripheral 10. The display screen W10 is a display screen on which device information such as the status of the multifunction peripheral 10, an address book, and system settings can be collectively displayed for each tab. Referring to FIG. 7 and FIG. 8, settings related to virus scanning that can be set via the system setting tab on the display screen W10 will be described.

Incidentally, the display screen W10 can be displayed by, for example, receiving selection of a display button provided on a home screen or the like, which is not illustrated. The display screen W10 can also be displayed as a Web-UI using a Web browser on a terminal device, such as a personal computer (PC) or a smart phone, which is not illustrated. In this case, the terminal device is configured to be able to output the setting content related to the virus scanning or the like received via the Web-UI to the multifunction peripheral 10.

FIG. 7 is a diagram illustrating a first virus scanning setting area R10 included in the system setting tab.

The first virus scanning setting area R10 includes a “perform virus scanning” pull-down, a virus scanning setting area R101, a pattern update setting area R103, a registration button B10, and a next button B12.

The “perform virus scanning” pull-down is a pull-down for receiving setting of enabling/disabling of execution of the virus scanning.

The virus scanning setting area R101 is a setting area for receiving settings of data (file) type as a target of the virus scanning, a setting of an execution schedule of the virus scanning, and the like. The virus scanning setting area R101 includes, as items for receiving settings of the data type as a target of the virus scanning: a “performing virus scanning on input/output data” check box for performing virus scanning on input/output data as a target at the time of an input or an output of data to or from the multifunction peripheral 10; a “performing virus scanning when an application is installed” check box for performing virus scanning on firmware update data, application data, or the like at the time of updating of firmware or installation of the application; a “performing virus scanning on a system or saved data” check box for performing virus scanning on the system or saved data (for example, apparatus setting data or data saved in a shared folder, a fax reception folder, or the like); and the like.

Note that examples of the input/output data to be subjected to the virus scanning by selecting the “performing virus scanning of input/output data” check box include job data, address book data, and document filing data (data in which a copied or faxed document, print data, scan data, or the like is stored such that they can be called when necessary) related to each mode.

The virus scanning setting area R101 includes, as items for receiving settings of the execution schedule of the virus scanning; a “performing scanning when the apparatus is started” check box for executing virus scanning when the multifunction peripheral 10 is started; a “performing scanning at a determined clock time” check box for executing virus scanning at a set clock time; an “executing scanning right now” button for immediately executing virus scanning (on-demand scanning) in response to a user operation; and the like.

The pattern update setting area R103 includes, as items for receiving the update settings (update schedule) of a virus definition file; a “performing updating when the apparatus is started” check box for updating the virus definition file when the multifunction peripheral 10 is started; a “performing updating at a determined clock time” check box for updating the virus definition file at a set clock time; a “executing updating right now” button for updating the virus definition file (on-demand updating) in response to a user operation; and the like. The user can perform the virus scanning setting by setting the “perform virus scanning” pull-down to be enabled, and designating a desired data type as a target of the virus scanning, designating an execution schedule of the virus scanning, or perform updating setting of the virus definition file, and selecting the registration button B10 in the virus scanning setting area R101 and the pattern update setting area R103.

Note that the next button B12 is a button for receiving an instruction for screen transition to a second virus scanning setting area R20, which will be described with reference to FIG. 8. Once an instruction for selecting the next button B12 is received from the user, the controller 11 displays the second virus scanning setting area R20, which will be described with reference to FIG. 8.

The second virus scanning setting area R20 illustrated as an example in FIG. 8 includes a message continuous display setting area R201, a message continuous display release setting area R203, a registration button B10, and a return button B14.

The message continuous display setting area R201 is a setting area for receiving settings regarding continuous display of the virus detection message indicating the infection with the virus as notification content. The message continuous display setting area R201 includes a “message continuous display” pull-down for receiving a setting for enabling/disabling continuous display of the virus detection message, a selection check box for receiving selection of a specific measure to which continuous display of the virus detection message is applied (“a change in file name”, “a change in file path”, “detachment of a device storing the file”, “deletion of the file”, “overwriting and saving of the file”, and “others (user settings)”) and a “reflection of updated location” check box.

In a case where the user desires continuous display of the virus detection message, the user selects “enable” from the “message continuous display” pull-down. The user can select a specific measure to which continuation of display of the virus detection message is to be applied by checking the selection check box corresponding to the desired specific measure.

A “reflect updated content” check box is a check box for receiving selection regarding whether to update the virus detection message based on content of change in a case where the display content to be displayed in the virus detection message is changed by the specific measure. In a case where the display content to be displayed in the virus detection message is changed by checking the “reflect updated content” check box, the user can update the virus detection message.

The message continuous display release setting area R203 is a setting area for receiving a setting regarding release of the continuous display of the virus detection message. The message continuous display release setting area R203 includes a “release message continuous display” pull-down for receiving a setting for enabling/disabling release of continuous display of the virus detection message and a selection check box (“user approval” and “display for XX minutes from first display”) for receiving selection of a release condition for releasing continuous display of the virus detection message.

Note that the release condition “user approval” is a release condition that allows the message continuous display to be released by providing a receiving mechanism for receiving an instruction for releasing the message continuous display in the virus detection message to be displayed and by the user selecting the receiving mechanism. The release condition “display for XX minutes from first display” is a release condition that releases the continuous display of the virus detection message at a timing at which a preset display time elapses. As the “first display” in this case, the timing at which the virus is detected may be set as “first display”, or the timing at which the display content of the virus detection message is updated by a specific measure may be set as “first display”. Note that the preset display time may be in any of units of minutes, units of hours, units of days, and units of years, or a specific date and time may be set as the release date and time of the continuous display.

In a case where the user desires to release the continuous display of the virus detection message, the user selects “enable” from the “release message continuous display” pull-down. The user can set the release of the continuous display of the virus detection message by checking the selection check box corresponding to the desired release condition.

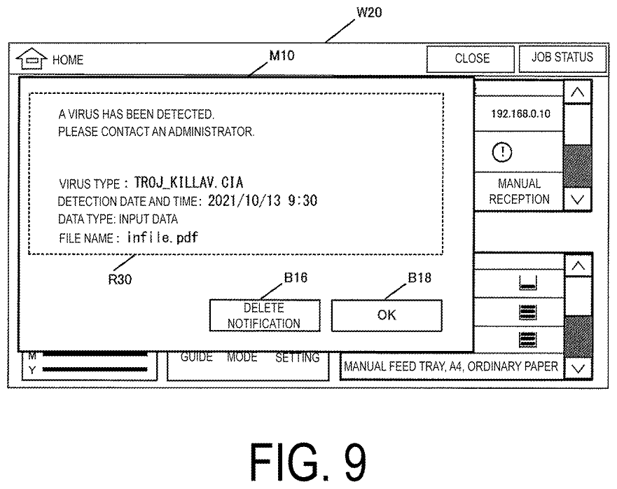

Next, a display mode of the virus detection message according to the first embodiment will be described. FIG. 9 is a diagram for explaining a configuration example of a virus detection message M10 indicating that a virus has been detected as display content in a case where the virus has been detected. Note that the virus detection message M10 illustrated as an example in FIG. 9 is a display example in which the message is displayed in a superimposed manner on the display screen W20 displayed on the display 13 of the multifunction peripheral 10.

Note that the virus detection message M10 can also be displayed via a Web browser on a terminal device, such as a PC or a smartphone, which is not illustrated.

The virus detection message M10 includes a message display area R30, a button B16 for deleting the notification, and an OK button B18. The message display area R30 is a display area for displaying a message (notification) indicating that a virus has been detected as display content. FIG. 9 illustrates example display content “A virus has been detected. Please contact an administrator . . . . Virus type: TROJ_KILLAV.CIA, detection date and time: 2021/10/13 9:30, data type: input data, file name: infile.pdf” as indication of virus detection.

The button B16 for deleting the notification is a button for receiving an instruction to delete the virus detection message M10. Once the user selects the button B16 for deleting the notification, the controller 11 terminates the display of the virus detection message M10 and deletes the information on the corresponding infected file from the file information table.

The OK button B18 is a button for receiving an input of an instruction to check the virus detection message M10 from the user. Once the user selects the OK button B18, the controller 11 ends the display of the virus detection message M10. In a case where the user selects the OK button B18, the controller 11 does not delete the information regarding the corresponding infected file from the file information table. It is possible to reuse the information regarding the infected file held by the file information table even in a case where the connection to the device storing the infected file is once released and is then established again, for example, by employing a configuration in which the information regarding the infected file is held by the file information table. This has the advantage that it is not necessary to generate the virus detection message regarding the infected file again.

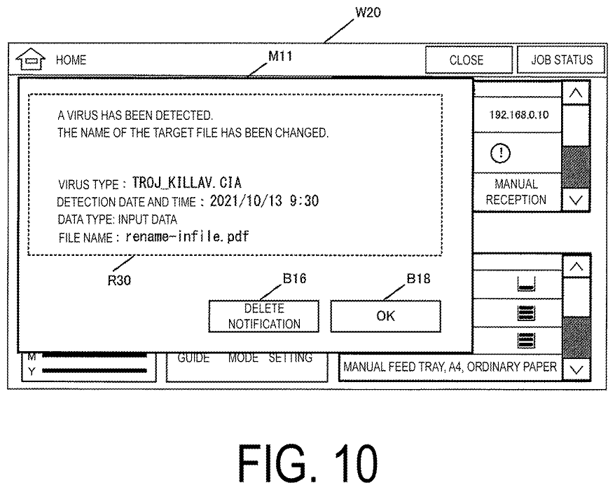

FIG. 10 is a diagram for explaining a configuration example of a virus detection message M11 continuously displayed in a case where a file name of an infected file is changed as a specific measure. Note that since the display configuration of the virus detection message M11 can have the same configuration as that of the virus detection message M10, the same parts will be denoted by the same reference signs, and description thereof will be omitted.

The virus detection message M11 illustrated as an example in FIG. 10 is different from the virus detection message M10 in the display content displayed in the message display area R30. In other words, the fact that the file name of the infected file has been changed and the changed file name are displayed as updated notification content in the message display area R30 of the virus detection message M11.

FIG. 10 illustrates an example in which display content “A virus has been detected. The file name of the target has been changed . . . . Virus type: TROJ_KILLAV.CIA, detection date and time: 2021/10/13 9:30, data type: input data, file name: rename-infile.pdf” is displayed in the message display area R30 as updated notification content.

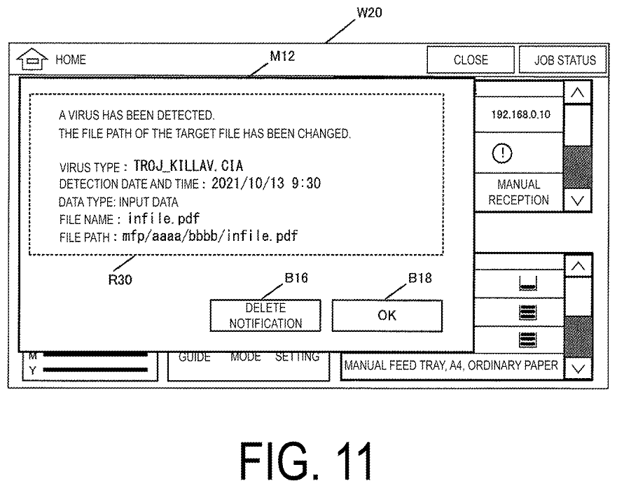

FIG. 11 is a diagram for explaining a configuration example of the virus detection message M12 that is continuously displayed in a case where the file path indicating the storage location of the infected file has been changed as a specific measure. Note that since the display configuration of the virus detection message M12 can be the same configuration as that of the virus detection message M10, the same parts will be denoted by the same reference signs, and description thereof will be omitted.

The virus detection message M12 illustrated as an example in FIG. 11 is different from the virus detection message M10 in the display content displayed in the message display area R30. In other words, the fact that the file path indicating the storage location of the infected file has been changed and the changed file path are displayed as updated notification content in the message display area R30 of the virus detection message M12.

FIG. 11 illustrates an example in which updated notification content “A virus has been detected. The file path of the target file has been changed . . . . Virus type: TROJ_KILLAV.CIA, detection date and time: 2021/10/13 9:30, data type: input data, file name: infile.pdf, file path: mfp/aaaa/bbbb/infile/pdf” is displayed in the message display area R30.

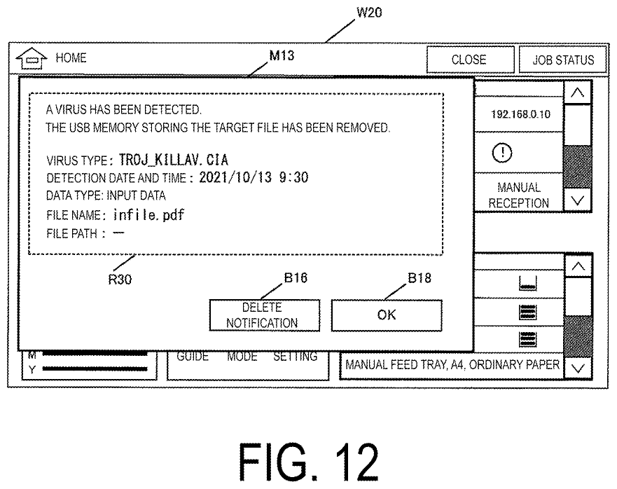

FIG. 12 is a diagram for explaining a configuration example of the virus detection message M13 continuously displayed in a case where the device storing the infected file is removed (when the mounting is released) as a specific measure. Note that since the display configuration of the virus detection message M13 can be the same configuration as that of the virus detection message M10, the same parts will be denoted by the same reference signs, and description thereof will be omitted here.

The virus detection message M13 illustrated as an example in FIG. 12 has different display content to be displayed in the message display area R30 from that of the virus detection message M10. In other words, the fact that the mounting of the device storing the infected file has been released and the file path to the detached device as “-” are displayed in the message display area R30 of the virus detection message M13.

FIG. 12 illustrates an example in which updated notification content “A virus has been detected. The USB memory storing the target file has been removed . . . . Virus type: TROJ_KILLAV.CIA, detection date and time: 2021/10/13 9:30, data type: input data, file name: infile.pdf, file path:-” is displayed in the message display area R30.

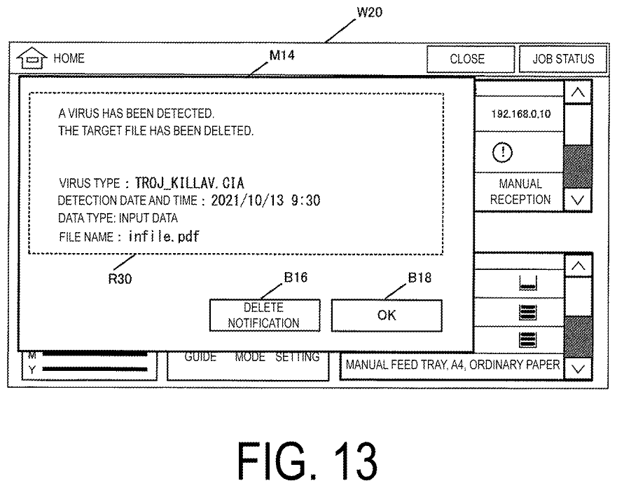

FIG. 13 is a diagram for explaining a configuration example of a virus detection message M14 that is continuously displayed in a case where the infected file is deleted as a specific measure. Note that since the display configuration of the virus detection message M14 can be the same configuration as that of the virus detection message M10, the same parts will be denoted by the same reference signs, and description thereof will be omitted here.

The virus detection message M14 illustrated as an example in FIG. 13 has different display content to be displayed in the message display area R30 form that of the virus detection message M10. In other words, the fact that the infected file has been deleted and the deleted file name are displayed as updated notification content in the message display area R30 of the virus detection message M14.

FIG. 13 illustrates an example in which updated notification content “A virus has been detected. The target file has been deleted . . . . Virus type: TROJ_KILLAV.CIA, detection date and time: 2021/10/13 9:30, data type: input data, file name: infile.pdf” is displayed in the message display area R30.

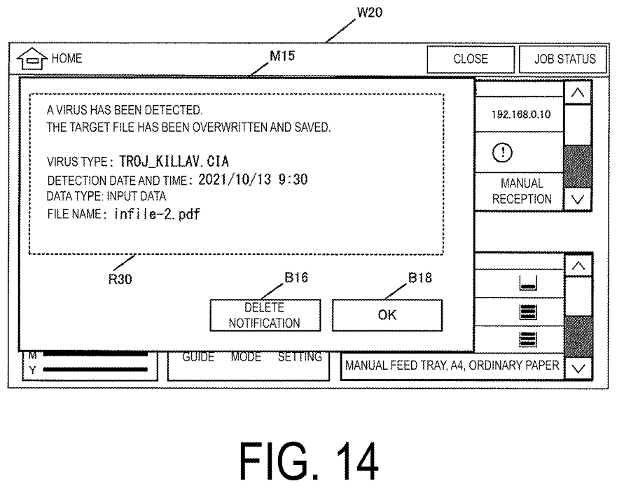

FIG. 14 is a diagram for explaining a configuration example of a virus detection message M15 that is continuously displayed in a case where the infected file is overwritten and saved as a specific measure. Note that since the display configuration of the virus detection message M15 can be the same configuration as that of the virus detection message M10, the same parts will be denoted by the same reference signs, and description thereof will be omitted.

The virus detection message M15 illustrated as an example in FIG. 14 is different from the virus detection message M10 in the display content displayed in the message display area R30. In other words, the fact that the infected file has been overwritten and saved, and the file name after the overwriting and the saving are displayed as updated notification content in the message display area R30 of the virus detection message M15.

FIG. 14 illustrates an example in which updated notification content “A virus has been detected. The target file has been overwritten and saved . . . . Virus type: TROJ_KILLAV.CIA, detection date and time: 2021/10/13 9:30, data type: input data, file name: infile-2.pdf” is displayed in the message display area R30.

As described above, according to the first embodiment, it is possible to continue the display indicating that the virus has been detected even in a case where the file becomes inaccessible as a result of a specific measure for cleaning, deletion, or isolation of the infected file and thereby to notify the user of the fact that the virus has been detected. In this case, since the notification indicating that the virus has been detected is continuously displayed until the user checks the notification, the user can recognize the fact that the virus has been detected. According to the first embodiment, file information that has been changed due to the specific measure is updated and displayed, and the user can thus accurately recognize the file condition of the file infected with the virus.

### 2. Second Embodiment

A second embodiment is a mode in which an operation on an infected file infected with a virus is disabled and a virus detection message is continuously displayed in a case where the virus detection message is not checked by a user.

### 2.1 Functional Configuration

Since a functional configuration of a multifunction peripheral according to the second embodiment can be similar to the functional configuration of the multifunction peripheral 10 according to the first embodiment, description thereof will be omitted here.

### 2.2 Processing Flow

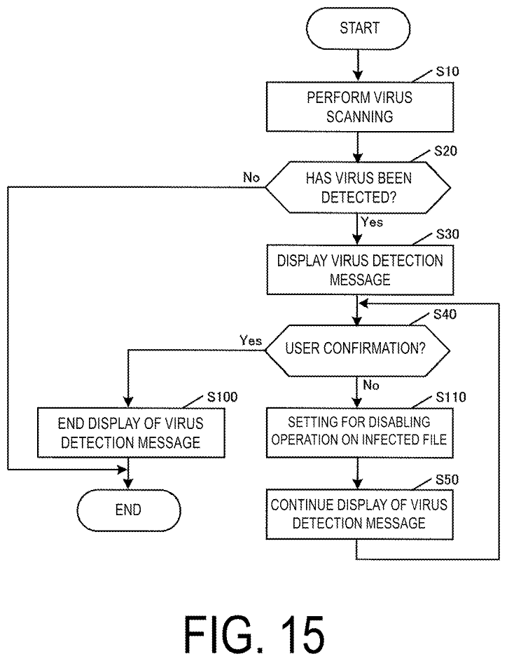

An entire processing flow according to the second embodiment can be processing in which the flowchart of FIG. 5 in the first embodiment is replaced with the flowchart of FIG. 15. Therefore, the same processing is denoted by the same step numbers, and description thereof may be omitted.

The controller 11 executes the processing regarding Step S10 to Step S30 described above in FIG. 5 and then determines whether the user has checked the virus detection message displayed on the display 13 (Step S40). In a case where it is determined that the virus detection message displayed on the display 13 has been checked by the user, the controller 11 ends the display of the virus detection message and ends the processing (Step S40; Yes→Step S100).

On the other hand, in a case where it is determined that the user has not checked the virus detection message displayed on the display 13, the controller 11 reads the file management program 233 and performs setting such that no operation can be made on the infected file (Step S40; No→Step S110). The controller 11 continues the display of the virus detection message until the user checks the virus detection message (Step S110→Step S50).

### 2.3 Operation Example

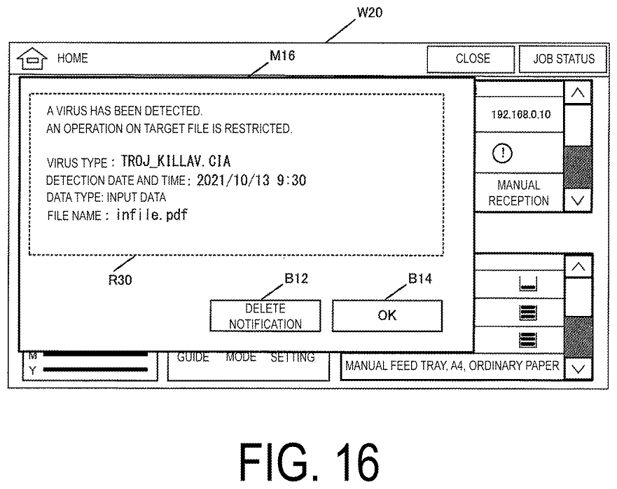

Next, a display mode of the virus detection message according to the second embodiment will be described. FIG. 16 is a diagram for explaining a configuration example of a virus detection message M16 indicating that a virus has been detected as display content in a case where the virus has been detected. Note that since the display configuration of the virus detection message M16 can be the same configuration as that of the virus detection message M10, the same parts will be denoted by the same reference signs, and description thereof will be omitted here.

FIG. 16 illustrates an example in which notification content continuously displayed “A virus has been detected. An operation on the target file is restricted . . . . Virus type: TROJ_KILLAV.CIA, detection date and time: 2021/10/13 9:30, data type: input data, file name: infile.pdf” is displayed in the message display area R30.

As described above, according to the second embodiment, an operation on the file infected with the virus cannot be performed in a case where the user does not check the notification indicating that the virus has been detected, the user can recognize that it is necessary to perform an action of confirming that the virus has been detected in order to perform any file operation. According to the second embodiment, an operation on the file infected with the virus cannot be performed in a case where the user does not check the notification indicating that the virus has been detected, and it is thus possible to reduce unnecessary operations on the file infected with the virus and to prevent the operations from spreading damage caused by the virus infection.

### 3. Third Embodiment

A third embodiment is a mode in which a notification provider that provides, to the user, a notification that a virus detection message is continuously being displayed for the user in a case where the user does not check the virus detection message and the virus detection message has continuously been displayed for a predetermined time or longer, is provided in addition to the configuration in the first embodiment. In the third embodiment, continuous display of the virus detection message updated in association with a specific measure will be described.

### 3.1 Functional Configuration

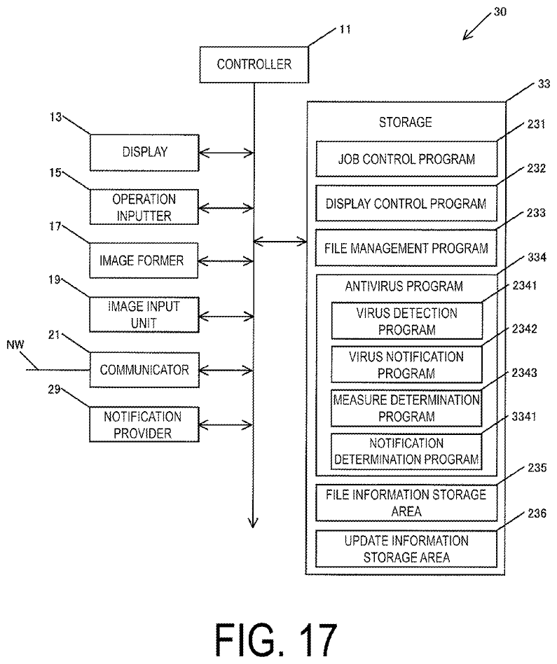

FIG. 17 is a diagram for explaining a functional configuration of a multifunction peripheral 30 according to the third embodiment. The multifunction peripheral 30 includes a notification provider 29 in addition to the configuration of the multifunction peripheral 10 according to the first embodiment and includes a storage 33 instead of the storage 23.

The notification provider 29 notifies the user of the fact that the virus detection message has been continuously displayed for a predetermined time or longer based on control performed by the controller 11. A light emitting device such as an LED lamp, a sound (voice) output device such as a voice read-aloud device or a beep sound generating device, or the like, for example, can also be used as the notification provider 29, in addition to a character information transmission mechanism such as a Web-UI, an electronic mail, a short message service (SMS), or a fax. The configuration of the notification provider 29 is not particularly limited as long as the notification provider 29 can notify the user of the fact that the notification is being continuously displayed with the configuration.

The storage 33 according to the third embodiment includes an antivirus program 334 in addition to the configuration of the storage 23. The antivirus program 334 includes a virus detection program 2341, a virus notification program 2342, a measure determination program 2343, and a notification determination program 3341.

The controller 11 that has read the notification determination program 3341 controls a timing counter such as a timer, which is not illustrated, to measure the elapse time after the updated virus detection message is displayed on the display 13. In a case where the measured display elapse time exceeds a preset display time threshold value (predetermined time), the controller 11 determines that the virus detection message has been continuously displayed for the predetermined time or longer without being checked by the user.

### 3.2 Processing Flow

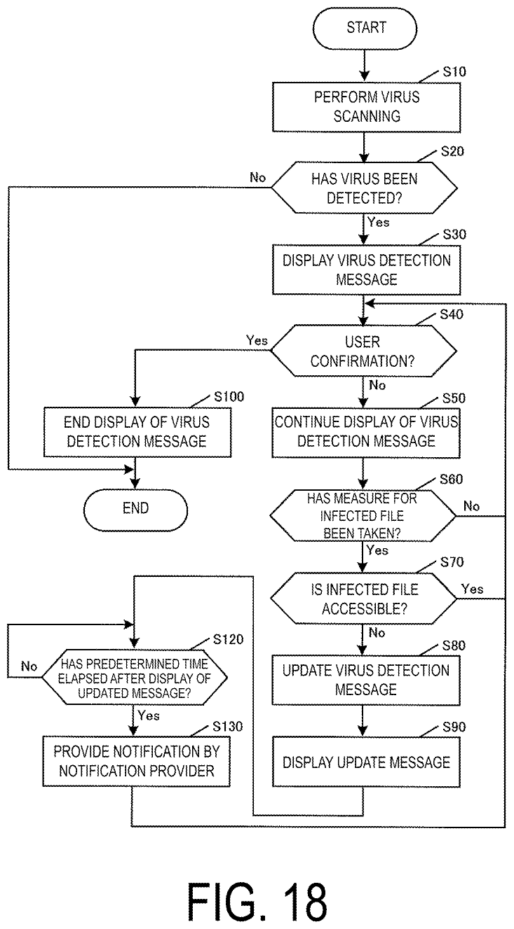

An entire processing flow according to the third embodiment can be processing in which the flowchart of FIG. 5 in the first embodiment is replaced with the flowchart of FIG. 18. Therefore, the same processing is denoted by the same step numbers, and description thereof may be omitted.

The controller 11 executes the processing in Step S10 to Step S90 described above in FIG. 5. The controller 11 reads the notification determination program 3341 and determines whether the display elapse time of the updated virus detection message displayed on the display 13 has exceeded the preset display time threshold value (predetermined time) (Step S90→Step S120).

In a case where it is determined that the display elapse time of the updated virus detection message has exceeded the preset display time threshold value (predetermined time), the controller 11 determines to provide notification by the notification provider 29. The controller 11 controls the notification provider 29 to notify the user of the fact that the virus detection message has continuously been displayed (Step S120; Yes→Step S130). On the other hand, in a case where it is determined that the display elapse time of the updated virus detection message has not exceeded the preset display time threshold value, the controller 11 continues to measure the display elapse time (Step S120; No).

### 3.3 Operation Example

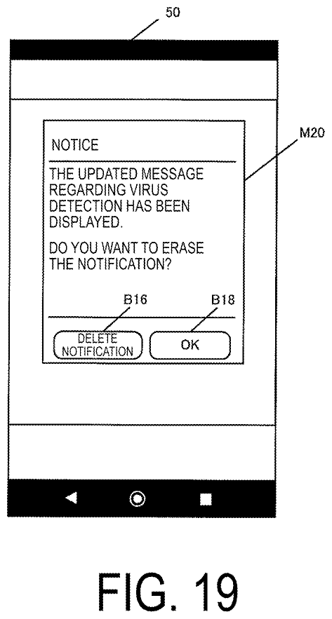

Next, an operation example according to the third embodiment will be described. FIG. 19 is a diagram for explaining an example of a notification that a virus detection message has continuously been displayed. FIG. 19 is an example in which a message M20 indicating that the virus detection message has continuously been displayed is transmitted as an SMS to a terminal device 50 used by the user.

The message M20 includes, as notification content, “The updated message regarding virus detection has been displayed. Do you want to erase the notification?”. In this case, it is also possible to display the button B16 for deleting the notification and the OK button B18 described in the first embodiment along with the message M20.

Note that in a case where it is not necessary to display the button B16 for deleting the notification and the OK button B18 together, or in a case of an apparatus configuration which does not include any transmission mechanism based on text information, it is also possible to notify the user of the fact that the virus detection message has continuously been displayed based on a light emission pattern of a light emitting device or an output pattern of a sound (voice) output device.

As described above, according to the third embodiment, it is possible to notify the user of the fact that the virus detection message has continuously been displayed in a case where the virus detection message has continuously been displayed for the predetermined time or longer without being checked by the user, in addition to the effects of the first embodiment. With such a configuration, the user can recognize that the virus has been detected even in a case where the user is located at a place where the user cannot check the display 13 of the multifunction peripheral 30.

The present disclosure is not limited to the embodiments described above and can be changed in various manners. In other words, embodiments obtained by combining technical mechanisms appropriately changed without departing from the gist of the present disclosure are also included in the technical scope of the present disclosure.

Although some parts of the above-described embodiments are described separately for convenience of explanation, it is a matter of course that combinations can be executed within a technically allowable range.

The programs running on each device in the embodiments are programs for controlling a CPU or the like (programs for causing a computer to function) to realize the aforementioned functions in the embodiments. The information handled by these devices is temporarily accumulated in a temporary storage device (for example, a RAM) at the time of processing, is then stored in a storage device such as a read only memory (ROM) or an HDD, and is read, corrected, and written by the CPU as needed.

The recording medium storing the programs may be any of a semiconductor medium (for example, a ROM, a nonvolatile memory card, or the like), an optical recording medium or a magneto-optical recording medium (for example, a digital versatile disc (DVD), a magneto optical disc (MO), a mini disc (MD), a compact disc (CD), a Blu-ray (trade name) disc (BD) or the like), a magnetic recording medium (for example, a magnetic tape, a flexible disk, or the like), and the like. Not only the aforementioned functions of the embodiments are realized by executing the loaded programs, but also the functions of the present disclosure may be realized by performing processing in cooperation with an operating system, another application program, or the like based on instructions of the programs.

In a case where the programs are distributed to the market, the programs can be stored and distributed in a portable recording medium, or can be transferred to a server computer connected via a network such as the Internet. In this case, it is a matter of course that the storage device of the server computer is also included in the present disclosure.

### REFERENCE SIGNS LIST

10, 30 Multifunction peripheral
11 Controller
13 Display
15 Operation inputter
17 Image former
19 Image inputter
21 Communicator
23, 33 Storage
231 Job control program
232 Display control program
233 File management program
234, 334 Antivirus program
235 File information storage area
236 Update information storage area
29 Notification provider
50 Terminal device

1. An information processing apparatus comprising:
one or more controllers that detect a virus and perform a specific measure on a file infected with the virus; and
a display that displays that the virus has been detected as display content based on control performed by the one or more controllers,
wherein the one or more controllers continue to display that the virus has been detected even in a case where the file becomes inaccessible as a result of the specific measure performed on the file.

2. The information processing apparatus according to claim 1,
wherein the one or more controllers update display content performed by the display based on the specific measure performed on the file.

3. The information processing apparatus according to claim 2,
wherein the specific measure performed on the file is any of a change in a file name of the file, a change in a file path indicating a storage location of the file, release of mounting of a device storing the file, deletion of the file, and overwriting and saving of the file.

4. The information processing apparatus according to claim 1,
wherein the one or more controllers disable any manipulation performed on the file and continues to display that the virus has been detected.

5. The information processing apparatus according to claim 1, comprising:
a notification provider that provides, to a user, a notification that the display indicating that the virus has been detected is being continued.

6. A virus detection display method comprising:
detecting a virus and performing a specific measure on a file infected with the virus;
displaying that the virus has been detected as display content; and
continuing to display that the virus has been detected even in a case where the file becomes inaccessible as a result of the specific measure performed on the file.
